(19) United States
(12) Patent Application Publication
(10) Pub. No.: US 2003/0152285 A1
(43) Pub. Date: Aug. 14, 2003

(54) Method of real-time recognition and compensation of deviations in the illumination in digital color images

(76) Inventors: Ingo Feldmann, Berlin (DE); Peter Kauff, Berlin (DE); Oliver Schreer, Berlin (DE); Ralf Tanger, Berlin (DE)

Correspondence Address: Law Offices of Karl Hormann, P. O. Box 381516, Cambridge, MA, 02238-1516, US

(21) Appl. No.: 10/351,012

(22) Filed: Jan. 25, 2003

(30) Foreign Application Priority Data
Feb. 3, 2002 (DE) 100 04 500.3

(51) Int. Cl. G06K 9/00; G06K 9/34

(52) U.S. Cl. 382/274; 382/173

(57) ABSTRACT

During post-processing of video data in a YUV color space it may be necessary, for instance for immersive video conferences, to separate a video object in the image foreground from the known image background. Hitherto, rapid, locally limited deviations in illumination in the actual image to be examined, in particular shadows and brightenings, could not be compensated. The inventive recognition and compensation method, however, can compensate in real time shadows and brightenings, even at great quantities of image data by directly utilizing different properties of the technically based YUV color space. Chrominance, color saturation and color intensity of an actual pixel (P₁) are approximated directly from associated YUV values (α, a, b) which leads to the avoidance of time-consuming calculations. The recognition of rapid deviations in illumination carried out in the YUV color space is based upon the approximation of a chrominance difference by an angle difference (α₁−α₂) of the pixels (P₁, P₂) to be compared, preferably in a plane (U, V) of the YUV color space. This proceeds on the assumption that the chrominance of a pixel at the occurrence of shadows and brightenings remains constant in spite of varying color saturation and color intensity. The method in accordance with the invention may be supplemented by a rapid decision program including additional decision parameters which excludes complex calculations of angle operations and separation error, even at significant deviations in illumination.

### BACKGROUND OF THE INVENTION

1. Field of the Invention

The invention, in general, relates to a method capable of real-time recognition and compensation of deviations in the illumination of digital color image signals for separating video objects as an image foreground from a known static image background by a pixel by pixel, component dependent and threshold value dependent comparison of color image signals between the actual pixel and an associated constant reference pixel in the image background within the YUV color space with the luminance Y and chrominance U, V color components transformed from a color space with the color components chrominance, color saturation and color intensity.

In the area of video post processing, the necessity by occur of separating foreground and background of an image scene. The operation is known as “separation” and can be performed, for instance, by “segmentation”. An example would be video scenes of a conference in which, as a video object in the foreground, a conference participant is separated from the image background for processing and transmission separate therefrom. For this purpose, conventional methods of real-time segmentation generate a difference image (difference-based segmentation) between a known reference-forming background image and the image of a video sequence actually to be examined. On the basis of the information thus gained, a binary (black-and-white) reference mask is generated which distinguishes foreground and background from each other. By means of this mask, a foreground object separated from the foreground object can be generated which may then be further processed. However, deviations in the illumination of the image to be examined pose a problem with respect to the reference background image.

Deviations in the illumination of an actual picture are caused by covering or uncovering the existing sources of illumination. In this connection, it is to be noted that in the present context covering and uncovering are to be viewed relative to a normally illuminated state of the image scene. Thus, the compensations to be performed are to revert the actually examined image area to its lighter or darker “normal state”. A further distinction is to be made between global and local deviations in illumination. Global deviations in the illumination are caused, for instance, by clouds passing over the sun. This leads to the entire scene being darkened with soft transitions. Such darkening or, correspondingly, lightening when the sun is uncovered again by the clouds, occur over a relative long interval of time of several seconds. In common image sequences of 25 images per seconds such changes in the illumination are to be classified as “slow”. Global deviations in illumination which affect an actual image slowly, may be compensated in real time by known methods of compensation. Local deviations in illuminations must be clearly distinguished from global deviations in illuminations. Hereinafter, they will be called “shadow” (in contrast to global “covering”) or “brightening” (in contrast to global “uncovering”). Shadow and brightening are locally narrowly limited and thus are provided with discontinuous edge transitions relative to the given background. They are caused by direct sources of illumination, such as, for example, studio lamps. It is to be noted that it is entirely possible that the sun, too, may constitute a direct source of illumination providing directly impinging light with local shadow or brightening, when the shadow is eliminated. In cooperation with a video object, for instance as a result of the movements of the conference participant, direct sources of illumination generate rapid deviations in illumination in an image. Thus, in the range of the arms of a conference participant the movements of the arms and hands generate, in rapidly changing and reversible form, strong shadow or brightening of the corresponding image sections. Accordingly, at image sequences of 25 Hz, there will occur, image by image, strong changes of the image contents as a result of the strong differences in intensity, which cannot be compensated, for instance, by known difference-based segmentation processes operating directly in the YUV color space. In consequence of the large differences in intensities relative to the reference background, the known processes erroneous evaluate such areas as a foreground and, hence, as belonging to the video object. Such areas are, therefore, erroneously separated in the difference mask.

2. The Prior Art

A known difference-based segmentation process, from which, as the most closely related prior art the instant invention is proceeding, has been disclosed by German laid-open patent specification DE 199 41 644 A1. The method there disclosed of a real-time segmentation of video objects at a known steady image background relates to the segmentation of foreground objects relative to a static image background. By using an adaptive threshold value buffer, global, continuous and slowly, relative to the image frequency, occurring deviations in illumination can be recognized and compensated. The known method operates by comparing the image actually to be segmented against a reference background storage. At the beginning of the actual process the background storage is initialized. For this purpose, an average is obtained of several images from a video camera in order to compensate for camera noise. The actual segmentation is carried out by separately establishing the difference between the individual components of the YUV color space followed by logical connection of the results on the basis of the majority decision dependent upon predetermined threshold values associated with the three components in the YUV color space. The result of the segmentation operation will generate a mask value for the foreground, i.e. a foreground object within the video scene (video object) when at least two of the three threshold value operations decide in favor of the “image foreground”, i.e., whenever the given differences are larger than the corresponding threshold value. Where this is not the case, the value determined will be set top “background”. The segmentation mask thus generated is thereafter further processed by morphological filters. The post-processed result of the segmentation is used to actualize the adaptive threshold value buffer. However, suddenly occurring or rapidly changing deviations in illumination can only by incompletely compensated by this known method.

Before describing the known shadow detection methods, it is necessary to defined the term “color space” as used herein (see H. Lang: “Farbmetrik und Farbfernsehen”, R. Oldenbourg Verlag, Munich-Vienna, 1978, in particular sections I and V). The color space represents possible representations of different color components for presenting human color vision. Proceeding upon the definition of “color valence” resulting from mixing three chrominances as component factors of the primary colors (red, green, blue) in the composite, the chrominances may be considered as spatial coordinates for spatially presenting the color valence. This results in the RGB color space. The points on a straight line intersecting the origin of a coordinate system here represent color valences of identical chrominance with equal shares of chrominance differing only in their color intensity (brightness). A change in brightness at a constant chrominance and a constant color saturation in this color space thus represent movement on a straight line through the origin of the coordinate system. The sensation characteristics “chrominance”, “color saturation” (color depth), and “color intensity” which are essential aspects of human vision, are important for identifying color, so that a color space (HSV color space with “hue” for “chrominance”, “saturation”, and “value”) may be set up in accordance with these sensation characteristics, which constitutes a natural system of measuring color, albeit with a polar coordinate system.

Video image transmission of high efficiency represents a technological constraint which renders reasonable a transformation (“coding”) of the color space adjusted to the human sensory perception of color into a technically conditioned color space. In television and video image transmission, use is made of the YUV color space, also known as chrominance-luminance color space, containing a correspondingly different primary valence system, also with a rectangular coordinate system. In this connection, the two difference chrominances U and V which consist of shares of the primary valences blue (=U) and red (=V) and Y are combined under the term “chrominance” of a color valence, whereas Y is the “luminance” (light density) of the color valence which is composed of all three primary valences evaluated on the basis of luminance coefficients. A video image consisting of the three primary colors is separated in the YUV color space into its shares of chrominance and luminance. It is important that the term “chrominance” be clearly distinguished from the term “chromacity”. In the YUV color space, color valances of identical chromacity (chromacity is characterized by two chrominance components) and differing light density are positioned on one straight line intersecting the origin. Hence, chrominance represents a direction from the origin. An interpretation of a color in the sense of chrominance, color saturation and color intensity, as, for instance, in the HSI/HSV color space, cannot, however, be directly carried over and deduced from the YUV values. Thus, a retransformation from the technically conditioned color space into a humanly conditioned color space, such as, for instance, the HSI/HSV color space usually occurs.

As regards “shadow detection”, G. S. K. Fung et al., by their paper “Effective Moving Cast Shadow Detection for Monocular Color Image Sequence” (ICIAP 2001, Palermo, Italy, September 2001), have disclosed a shadow recognition during segmentation of moving objects during outdoor picture taking with a camera, the outdoor serving as an unsteady unknown background. Segmentation takes place in the HLS color space which is similar to the HSV color space described supra, wherein the color component “L” (luminosity) is comparable to color intensity. In this known method, too, shadows are considered in terms of their property of darkening the reference image with the color remaining unchanged. However, constant chrominance is assumed in the area of the shadow, which is not correct if chrominance is defined as luminance. For it is luminance which is reduced in the shade. Hence, it must be assumed that in this paper, the term “chrominance” indeed refers to “chromacity”. Which is to be assumed to be constant at a shadow which still generates color at the object. In the known method, the segmentation of the objects is carried out forming gradients. The utilization of the HSV color space for characterizing shadow properties is also known from R. Cucchiara et al.: “Detecting Objects, Shadows and Ghosts in Video Streams by Exploiting Color and Motion Information” (ICIAP 2001, Palermo, Italy, September 2001). The assumption of constancy of the chrominance at changing intensity and saturation of the pixel chrominance in the RGB color space may also be found in W. Skarbek et al.: “Colour Image Segmentation—A Survey” (Technical Report 94-32, FB 13, Technische Universität Berlin, October 1994, especially page 15). In this survey of color image segmentation “Phong's Shadow Model” has been mentioned, which is referred to for generating reflecting and shaded surfaces in virtual realities, for instance for generating computer games. A parallel is drawn between “shadowing” and “shadow”, and the assumption which was made is verified. Of course, prior statements regarding the case of shadow” may be analogously applied to brightenings.

Since for the method of recognition and compensation in accordance with the invention its ability to process video image data in real time is of primary importance which requires the taking into account of many technical constraints, the characterization of the effects of rapid deviations in illumination in the transformed technically based YUV color space is to be given preference. Thus, the invention proceeds from German laid-open patent specification DE 199 41 644 A1 discussed above, which describes a difference-based segmentation method with an adaptive real-time compensation of slow global illumination changes. This method, by its implemented compensation of slow illumination changes, yields processing results during segmentation of but limited satisfaction.

### OBJECTS OF THE INVENTION

Thus, it is an object of the invention so to improve the known method of the kind referred to supra to enable in real time the compensation of rapid changes in illumination causing locally sharply limited shadows of rapidly changing form within the image content.

Another object of the invention is to improve the known method such that the quality of processing results are substantially improved.

Yet another object of the invention is to improve the known method such that it may be practiced in a simple manner and is insensitive in its operational sequence, and, more particularly, to occurring changes in illumination.

Moreover, it is an object of the invention to provide an improved method of the kind referred to the practice of which is simple and, hence, cost efficient.

Other objects will in part be obvious and will in part appear hereinafter.

### BRIEF SUMMARY OF THE INVENTION

In the accomplishment of these and other objects, the invention, in a preferred embodiment thereof, provides for a method of real-time recognition and compensation of deviations in the illumination of digital color image signals for separating video objects as an image foreground from a known static image background by a pixel-wise component and threshold value dependent color image signal comparison between an actual pixel and an associated constant reference pixel in the image background in a YUV color space with color components luminance Y and chrominance U, V transformed from color space with color components chrominance, color saturation and color intensity, in which recognition of locally limited and rapidly changing shadows or brightenings is carried out directly in the YUV color space and which is based upon determination and evaluation of an angular difference of pixel vectors to be compared between an actual pixel and a reference pixel approximating a chrominance difference under the assumption that because of the occurring shadows or brightenings which at a constant chrominance cause only the color intensity and color saturation to change, the components Y, U and V of the actual pixel decrease or increase linearly such that the actual pixel composed of the three components Y, U, V is positioned on a straight line between its initial value before occurrence of the deviation in illumination and the YUV coordinate leap, whereby the changing color saturation of the actual pixel is approximated by the distance thereof from the origin of a straight line intersecting the origin of the YUV color space, the changing color intensity of the actual pixel is approximated by the share of the luminance component and the constant chrominance of the actual pixel is approximated by the angle of the straight line in the YUV color space.

In the recognition and compensation method the physical color parameters a approximated directly by the technical color parameters in the YUV color space. Thus, the advantage of the novel method resides in the direct utilization of different properties of the YUV color space for detecting rapid deviations in illumination and, hence, for recognizing local shadows and brightenings. The intuitive color components chrominance, color saturation and color intensity of a pixel are approximated directly from the YUV values derived by the method. On the one hand, this reduces the requisite calculation time by elimination of color space transformations and, on the other hand, the calculation time is reduced by the applied approximation which requires fewer calculation steps than the detailed mathematical process and is thus faster. However, the approximation in the range of the occurring parameter deviations is selected sufficiently accurately that the recognition and compensation method in accordance with the invention nevertheless attains high quality at a rapid detection in real time, even at large quantities of image data. The recognition and compensation of shadows and brightenings carried out in the YUV color space is based upon a determination of the angle difference to be determined of the pixel vectors in the YUV color space. The basis of this simplified approach is that in general it is only the difference in the chrominance of two images to be compared (reference image background and actual foreground image) which is taken into account. This difference in chrominance is approximated by an angle difference in the YUV color space. Furthermore, the assumption is utilized and realized that the chrominance of a pixel does not change in case of a change of illumination in large areas, and that a change of illumination only leads to a reduction in color intensity and color saturation. Thus, a pixel (always to be understood in the sense of color valence of a pixel and not as pixel in the display unit itself, at the occurrence of a shadow or brightening, changes its position on a straight line intersecting the origin of the YUV color space. In this connection it is to be mentioned that only such shadows and brightenings can be detected which still generate the actual chrominance on the object notwithstanding reduced or increased intensity and saturation or notwithstanding reduced or significantly increased luminance. An almost black shadow or an almost white brightening does change the chrominance of a pixel and cannot be detected in a simple manner. In the claimed recognition and compensation method in accordance with the invention the constant chrominance of a pixel is approximated by the angle of the straight line in the YUV color space which extends through the three-dimensional color cube of the actual pixel and the origin of the YUV color space. The difference of the chrominances between the actual pixel in the image foreground and the known reference pixel in the image background may thus be viewed as an angle function between the two corresponding straight lines through the three-dimensional color cubes of these pixels. To arrive at a decision (foreground or background), the angle function will than be compared against a predetermined angle threshold value. In the inventive method color saturation is then approximated as the distance of the three-dimensional color cube of the actual pixel on the straight line from the origin, and the color intensity is approximated by the associated luminance component.

The straight line positioned in the YUV color space is defined by a spatial angle. This angle may be defined by determining the angles of the projected straight lines in two planes of the coordinate system. A reduction in further calculating time is obtained by always considering only one angle of the straight line projected into one plane. Applying this consideration in all instances to all the pixels to be processed leads to a permissible simplification of the angle determination through a further approximation step for analyzing changes in chrominance. Thus, only one angle in one of the spatial planes needs to be determined and, for establishing the difference, to be compared with the angle of the associated reference pixel in the same plane, for defining the difference in chrominance of each actual pixel.

Further advantageous embodiments and improvements wrought by the invention will be set forth hereinafter. They will, in part, relate to specifications for further enhancing and accelerating the method in accordance with the invention, by further simplifying steps and improvements. In accordance with these improvements a shadow or brightening range will be identified in a simplified manner by the fact that in spite of the differences between saturation and luminance of two pixels to be compared no substantial change in color will result. Furthermore, in case of a shadow, the luminance has to be negative in view of the fact that a shadow always darkens an image. Analogously a change in luminance as a result of increased brightness must always be positive. For approximating the chrominances use may be made of the relationship between those two color space components which form the plane with the angle to be determined, with the smaller of the two values being divided by the larger value. By integrating the compensation method in accordance with the invention into a segmentation method it is possible to generate a substantially improved segmentation mask. Shadows and brightenings in conventional segmentation methods affect errors or distortions in the segmentation mask. With a corresponding recognition and compensation module, post-processing of shaded or brightened foreground areas of a scene previously detected by the segmentation module, may be carried out. This may lead to a further acceleration of post-processing. Areas detected as background need not be post-processed in respect of recognizing shadow or brightening. Complete image processing without prior segmentation and other image processing methods will profit from an additional detection of rapidly changing local shadows or brightenings. In order to avoid repetitions, reference should be had to the appropriate section of the ensuing description.

For further understanding, different embodiments of the compensation method in accordance with the invention will be described on the basis of exemplarily selected schematic representations and diagrams. These will relate to locally limited sudden shadows which in real life occur more often than brightening relative to a normal state of an image. An analogous application to the case of a sudden brightening is possible, however, without special measures. The method in accordance with the invention includes the recognition and compensation of shadows as well as brightenings.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 is a camera view of a video conference image, reference background image;

FIG. 2 is a camera view of a video conference image, actual image with video object in the foreground;

FIG. 3 is the segmented video object of FIG. 2 without shade recognition, in accordance with the prior art;

FIG. 4 is the segmented video object of FIG. 2 with shade recognition;

FIG. 5 is the binary segmentation mask of the video object of FIG. 2 after shade recognition in the YUV color space;

FIG. 6 schematically shows the incorporation of the recognition and compensation method in accordance with the invention in a segmentation method;

FIG. 7 depicts the YUV color space;

FIG. 8 depicts the chrominance plane in the YUV color space; and

FIG. 9 depicts an optimized decision flow diagram of the recognition and compensation method in accordance with the invention as applied to shade recognition.

### DETAILED DESCRIPTION OF PREFERRED EMBODIMENTS

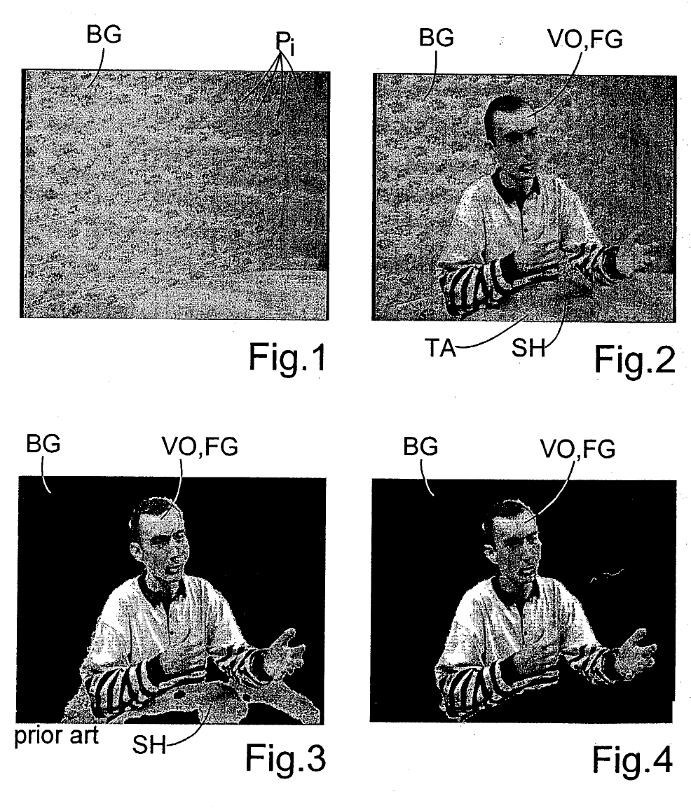

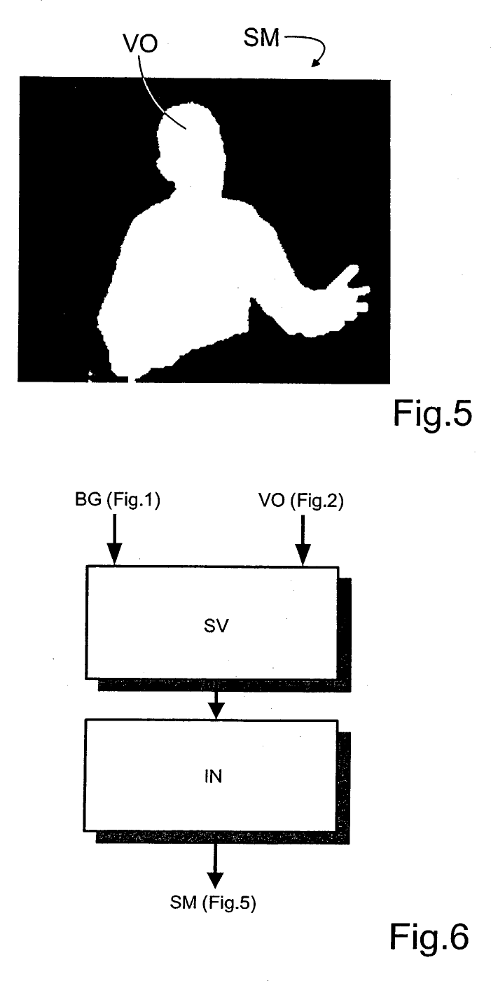

FIG. 1 depicts a steady background image BG which may be applied as a spatially and temporally constant reference background in the method in accordance with the invention. It represents areas structured and composed in terms of characteristic color and form by individual pixels Pᵢ which are known as regards their chrominance, color saturation and color intensity components as adjusted to human vision and which are stored in a pixel-wise manner in a reference storage. FIG. 2 represents an actual image of a conference participant as a video object VO in image foreground FG in front of the known image background BG. Substantial darkening of the effected image areas may be clearly discerned in the area of arms and hands of the conference participant VO on the table TA as part of the image background BG. This shadow formation SH is caused by the movement of the conference participant VO in front of studio illumination not shown in FIG. 2. Brightening might occur if upon initializing the image background there had appeared a reflection of light, caused, for instance, by light reflected from the background. This would also constitute a deviation from a “normal” reference background which because of the substantial differences in intensity would during detection logically have been recognized as foreground. In that case compensation would also be necessary.

FIG. 3 depicts the separated image, in accordance with the prior art, of the conference participant VO following segmentation without consideration of shadows. It may be clearly seen that the shaded area SH has been recognized as foreground FG and, therefore, cut out by the known difference-based segmentation method because of the substantial differences in intensity relative to the reference background BG. This results in an incorrect segmentation. By comparison, FIG. 4 depicts segmentation incorporating the recognition and compensation method in accordance with the invention. In this case, the shades area SH has been recognized as not being associated with the conference participant VO and has correspondingly been applied to the known background BG. Thus, the separation corresponds precisely to the contour of the conference participant VO. FIG. 5 depict a binary segmentation mask SM separated into black and white pixels, of the actual video image which has been generated by incorporating the inventive recognition and compensation method in the YUV color space in real time with due consideration of local rapidly changing deviations in illumination. The contour of the conference participant VO can be recognized in detail and correctly. Accordingly, image post-processing may follow. FIG. 6 is a block diagram of a possible incorporation IN in a segmentation method SV of the kind known, for instance, from German laid-open patent specification DE 199 41 644 A1. Incorporation takes place at the site of the data stream at which the conventional segmentation which distinguishes between image foreground and image background on the basis of establishing the difference between the static image background and the actual image, has been terminated. For further reducing the calculation time only the pixels previously recognized as image foreground FG will be compared by the inventive recognition and compensation method in a pixel-wise manner with the known image background BG which includes the performance of an approximation analysis in the technically based YUV color space without the time consuming transformation into a human vision based color space. In conformity with the results, pixels previously recognized as incorrect will be applied to the image background BG. The corrected segmentation result may then be further processed and may be applied, for instance, to an adaptive feed-back in the segmentation method SV.

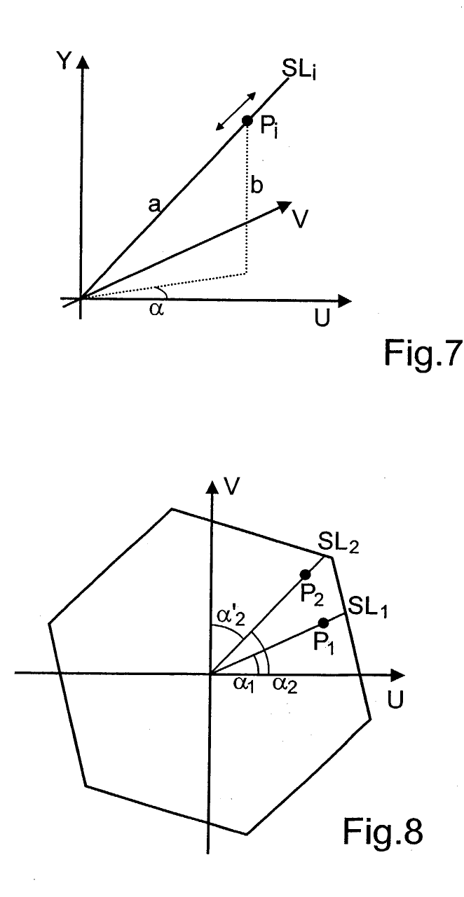

FIG. 7 represents a Cartesian coordinate system of the YUV color space. The chrominance plane is formed by the chrominance axes U and V. The luminance axis Y forms the space associated therewith. Y, U and V are technically defined chrominances not connected to any natural chrominances, but which may be converted by transformation equations. Since this conversion is very time consuming which prevents their execution in real time in connection with large quantities of image data, no such conversions are carried out by the inventive recognition and compensation method. Instead, it approximates naturally based chrominances to technically based chrominances. Assumptions known from naturally based color space are analogously transformed to the technically based color space. The permissibility of this approach is confirmed by the excellent results of the inventive method (see FIG. 4).

In a YUV color space FIG. 7 depicts the movement of a point or cube Pᵢ which represents the color characteristics of an actual pixel, on a straight line SLᵢ through the origin of the coordinate system. The YUV color space is a straight line which connects the sites of the same chromacity (chrominance components U and V) at differing luminance (luminance Y). In the rectangular HSV color space based on human vision, a pixel composed of the three color components in case of shadow formation (or brightening) is of constant chrominance but variable color saturation and color intensity. Analogously therewith, the method in accordance with the invention utilizes, in the YUV color space, a shift of the actual pixel Pᵢ along the straight line SLᵢ. In the YUV color space the chrominance is generally approximated by the spatial angle which in the embodiment shown is the angle α between the straight line SLᵢ and the horizontal chrominance axis U projected into the chrominance plane U, V. The color saturation is then approximated by the distance a of cube Pᵢ on the straight line SLᵢ from the origin, and the color intensity is approximated by the component b on the luminance axis Y.

FIG. 8 depicts the chrominance plane of the YUV color space. The color valences depicted in this color space are disposed within a polygon which in the example shown is a hexagon. Two points P₁, P₂ are drawn on two straight lines SL₁, SL₂ with angles α₁ and α_{2.} The indices i=1 and 2 respectively present the actual image (1) and the reference background (2). The angle α₂′ represents the conjugate angle of angle α₂ relative to the right angle of the UV plane (required for specification.) If points P₁ and P₂ do not differ, or differ but slightly, in the chrominance, i.e. if the two straight lines SL₁, SL₂ are superposed or closely adjacent (dependent upon a default threshold value Δα), there will be a change of the image as a result of shadow or brightening. In that case the recognition and compensation method in accordance with the invention will decide that the actual point₁ is to be attributed to the back ground. If, on the other hand, there is a difference in chrominance, it is to be assumed, that the objects are differently viewed objects and that the actual point P₁ is to be attributed to the foreground. The chrominance difference of the two point P₁ and P₂ will then be approximated by the angle difference α₁−α₂ in the chrominance plane U, V. These assumption are equally applicable for recognizing shadows and brightenings.

For defining the angle difference α₁−α₂ in the embodiment selected, it is necessary first to define the angle α₁, α₂ from the associated U and V values. Basically, angle α in the plane is

$$α = arctan ( \frac{v}{u} )$$

In the recognition and compensation method in accordance with the invention, the arctan operation necessary for defining the angle may also be approximated for reducing the calculation time. For this purpose the ratio of the components U/V or V/U is utilized such that the larger of the two components is always divided by the smaller one. It is necessary to decide which values are to be drawn upon for the comparison. In the event, the same procedure is to be applied for the actual image and the reference-forming image. In case different quotients result for the actual pixel and the associated reference pixel, a procedure must be selected which is valid for both pixels. This is permissible, and yields excellent results, because equal chrominances are located closely together and thus lead to but a small error in the approximation. If the decision is incorrect, however, the arctan formation will be incorrect also. this implies that the two pixels in the plane are spaced far apart and that a large angle difference results, the error in approximation is again without effect. After all, the purpose of the recognition and compensation method in accordance with the invention is to determine a qualitative difference in chrominance rather than a quantitative one.

The approximation by direct quotient formation may be derived from the Taylor expansion approximation. The nilth and first member of this approximation of the arctan operation is

$$arctan ( x ) = {\sum }_{k = 0}^{1} {( - 1 )}^{k} \frac{{x}^{2 k + 1}}{2 k + 1} = x - \frac{1}{3} {x}^{3}$$

For |x|<1 (where x is an arbitrary number) the approximation can again be approximated by

arctan(x)≈α where x=V/U.

Since it is only the difference between two angles α₁−α₂ which is of concern in the recognition and compensation method in accordance with the invention, one may, in case of |α₁|>1, instead of angle α₁=Vᵢ/Uᵢ also consider the conjugate angle α₁′=(90°−αᵢ) (see supra). In accordance with the above, αᵢ′ then is

$${α}_{i} \approx \frac{v}{u}$$

since |V/U|>1 equals U/V≦1 which is assumed to be U/V<1.

Accordingly, in the method in accordance with the invention it is possible to approximate the determination of the required angle difference by a simple quotient formation of the corresponding axis sections U, V in the chrominance plane, with the larger value always being divided by the smaller value. The same holds true for a projection of the straight lines in one of the two other planes of the YUV color space.

In addition to this specification for simplifying the method further threshold values and additional available data may be taken into consideration as further specifications. This leads to a complex decision frame for simplifying the method in accordance with the invention without loss of quality and which in its real time capacity may be significantly improved even in connection with large images to be processed. On the one hand, the further specifications, in case of shadow formation, may be the utilization of the fact that shadows darken an image which is to say that only those regions in an actual image may be shadows where the difference between the luminance values Y₁, Y₂ for the actual pixel P₁ and for the corresponding pixel P₂ from the reference background storage is less than zero. In the area of shadows the following is true: ΔY−Y₁−Y₂<0. The result is a negative ΔY. In the area of brightening ΔY=Y₁−Y₂>0 is true analogously with a positive ΔY. On the other hand, for stabilizing the recognition and compensation method in accordance with the invention additional threshold values may be added, in particular a chrominance threshold value ε as minimum or maximum chrominance value for U or V and a luminance threshold value Yₘᵢₙ or Yₘₐₓ as a minimum or maximum value of luminance Y. A projection of the straight lines in other planes correspondingly adjusted threshold values are to be assumed for the corresponding axes.

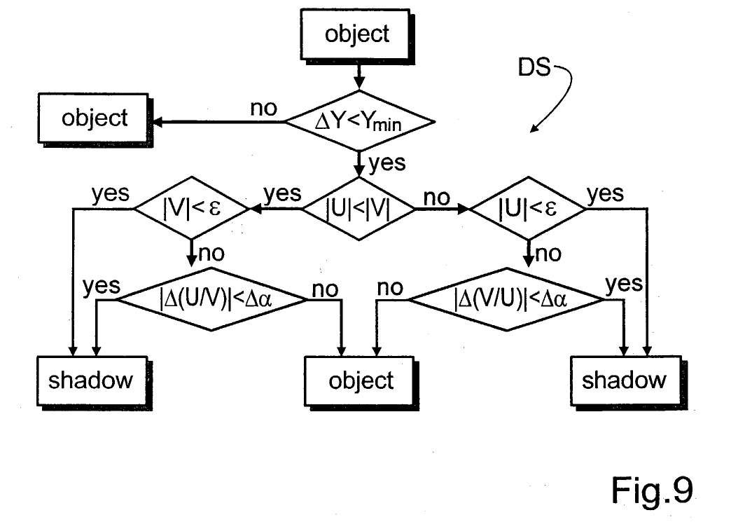

In FIG. 9 there is shown a complete decision flow diagram DS for the detection of shadows exclusively by the recognition and compensation method in accordance with the invention, which excludes complex mathematical angle operations and segmentation errors for very low color intensities. This leads to results which require insignificant calculation times. In addition to the approximation of the chrominance difference by means of the angle difference α₁−α₂ and comparison with a threshold value for an angle difference Δα additional luminance data ΔY are also utilized and the two further threshold values ε and Yₘᵢₙ are added.

In the selected embodiment, the input of the decision diagram DS is the presegmented conventional segmentation mask. This examines only pixels which have been separated as video object in the image foreground (designated “object” in FIG. 9). Initially, the determined difference in luminance ΔY=Y₁−Y₂ is compared with the predetermined negative threshold value Yₘᵢₙ. This ensures that only pixel difference values beginning at (in the sense of “smaller than”) a predetermined maximum brightness are being used. Since the luminance threshold value Yₘᵢₙ is a negative one, the value of the used luminance difference will always be greater than a predetermined minimum threshold value. The negative luminance threshold value Yₘᵢₙ also ensures that the in processing an actual pixel it can only be one from a shaded area since in that case Yₘᵢₙ is always negative. A shadow will darken an image, i.e. it reduces its intensity. In that case a more extensive examination will take place. Otherwise, the process is interrupted and the actually processed pixel is marked for the foreground (the same is true, by analogy, for a recognizable brightening of the image).

The next step in the decision diagram is the decision which of the two chrominance components U, V is to be the numerator or denominator in the chrominance approximation. For this purpose, before any chrominance approximation, the amount of the greater of the two components will be compared with the minimum chrominance threshold value ε which determines a maximum upper limit for the chrominance components U or V. Thereafter, the chrominance approximation is formed by the ratio |Δ(U/V)| or |Δ(V/U)|, wherein

$$\vert Δ ( U / V ) \vert = \vert \frac{{U}_{actualimage}}{{V}_{actualimage}} - \frac{{U}_{reference background storage}}{{V}_{reference background storage}} \vert$$

or vice versa, with indices “1” for “actual image” and “2” for “reference background storage”. The result of this operation is then compared with the threshold value of the angle difference Δα. Only if the result is less than the threshold value Δα, will the actually processed pixel, previously marked “object”, be recognized as a pixel in the shadow area (designated “shadow” in FIG. 9) and corrected by being marked as background. The corrected pixels may then be inserted into the adaptive feed back during the segmentation process from which the issuing segmentation mask may also originate.

By means of the inventive recognition and compensation method a shadow area will be identified, for instance, by the fact that in spite of the differences of saturation and luminance of two pixels to be compared (of the reference background image and of the actual image) no substantial change in chrominance will result. Furthermore, the change in brightness must be negative since a shadow always darkens an image. For approximating the chrominances the ratio of the two U, V components is always used. The smaller one of the two values must always be divided by the greater one (where both values are identical the value of the result will be 1.

### LIST OF REFERENCE CHARACTERS

List of Reference Characters

| a | Distance Pᵢ on SLᵢ from origin |
|---|---|
| b | Share of Pᵢ on the luminance axis Y |
| BG | Image background |
| DS | Decision Diagram |
| FG | Image foreground |
| HSV | color space based on human vision (chrominance, color |
| | saturation, color intensity) |
| i | Pixel index |
| IN | Integration in segmentation process |
| object | Image foreground |
| Pᵢ | Pixel (Valence in color space) |
| SH | Shadow |
| shadow | Image background |
| SL | Straight line |
| SM | Segmentation mask |
| SV | Segmentation method |
| TA | Table |
| U | Horizontal chrominance component |
| V | orthogonal chrominance component |
| VO | Video object |
| Y | Luminance component |
| Yₘᵢₙ | Minimum luminance threshold value |
| Yₘₐₓ | Maximum luminance threshold value |
| YUV | Technically based color space (chrominance, luminance) |
| α | Angle between the projected SL and a color space axis |
| Δα | Threshold value of Angle difference |
| α′ | Conjugate angle |
| ε | Chrominance threshold value |
| ΔY | Luminance difference |
| 1 | Index for “actual image” in foreground |
| 2 | Index for “background image” |

What is claimed is:

1. A method of real-time recognition and compensation of deviations in the illumination of digital color image signals for separating video objects as an image foreground from a known static image background by a pixel-wise component and threshold value dependent color image signal comparison between an actual pixel and an associated constant reference pixel in the image background in a YUV color space with color components luminance Y and chrominance U, V transformed from a color space with color components chrominance, color saturation and color intensity,
characterized by recognition of locally limited and rapidly changing shadows or brightenings is carried out directly in the YUV color space and which is based upon determination and evaluation of an angular difference of pixel vectors to be compared between an actual pixel (P₁ and a reference pixel approximating a chrominance difference under the assumption that because of the occurring shadows or brightenings which at a constant chrominance cause only the color intensity and color saturation to change, the components Y, U and V of the actual pixel decrease or increase linearly such that the actual pixel composed of the three components Y, U, V is positioned on a straight line between its initial value before occurrence of the deviation in illumination and the YUV coordinate leap, whereby the changing color saturation of the actual pixel is approximated by the distance thereof from the origin of a straight line intersecting the origin of the YUV color space, the changing color intensity of the actual pixel is approximated by the share of the luminance component and the constant chrominance of the actual pixel is approximated by the angle of the straight line in the YUV color space.

2. The method of claim 1, characterized by the fact that the angle difference of the pixel vectors to be compared is approximated in space by an angle difference (α₁−α₂) in the plane, whereby the angles (α₁−α₂) are disposed between the projection of the given straight line (SL₁, SL₂) intersecting the actual pixel (P₁) or the reference pixel (P₂) into one of the three planes in the YUV color space and one of the two axes (U) forming the given plane (U, V).

3. The method of claim 2, characterized by the fact that as a specification the approximation is carried out with the additional knowledge that only those areas of pixels (Pᵢ) can be shadows or brightenings for which the difference in luminance values (ΔY) between actual pixel (P₁) and reference pixel (P₂) is less than nil at the occurrence of shadow and greater than nil at the occurrence of brightenings.

4. The method of claims 3, characterized by the fact that additional threshold values are incorporated for stabilizing the process.

5. The method of claim 4, characterized by the fact that at an angle approximation in the UV plane a chrominance threshold value (ε) is incorporated as a minimum chrominance value for the horizontal chrominance component (U) and/or the orthogonal chrominance component (V) and a luminance threshold value (Yₘᵢₙ) are incorporated as a minimum value of the chrominance (Y).

6. The method of claim 5, characterized by the fact that as an additional specification the angle (α) of the straight line (SL) projected into the plane (UV) relative to one of the two axes (U) which may be defined by arctan formation of the quotient of the components (U/V) of the pixel (P₁) in this plane (UV) and which is approximated by the quotient (U/V) or its reciprocal (V/U) as a function of the ratio of sizes between the two components (U, V) such that the lesser value is divided by the larger value.

7. The method of claim 6, characterized by the fact that the specifications are summarized in a common decision diagram (DS).

8. The method of claim 7, characterized by the fact that it is incorporated as a supplement (IN) into a difference-based segmentation process (SV) for color image signals as a post-processing step whereby only pixels associated in the segmentation process with the video object in the image foreground (VO) are processed as actual pixels.
